(19) United States
(12) Patent Application Publication
(10) Pub. No.: US 2022/0234172 A1
(43) Pub. Date: Jul. 28, 2022

(54) HIGH LEVERAGE LOCKING PLIERS

(71) Applicant: Snap-on Incorporated, Kenosha, WI (US)

(72) Inventors: Daniel M. Eggert, Kenosha, WI (US); Douglas Moyer, Racine, WI (US)

(73) Assignee: Snap-on Incorporated, Kenosha, WI (US)

(21) Appl. No.: 17/161,010

(22) Filed: Jan. 28, 2021

(51) Int. Cl. B25B 7/02; B25B 7/08; B25B 7/16

(52) U.S. Cl. CPC B25B 7/02; B25B 7/16; B25B 7/08

(57) ABSTRACT

High leverage locking-type pliers incorporating a four bar linkage system adapted to amplify force applied by the user to an object gripped between jaws of the pliers. The pliers include first and second handles, first and second jaws, and a center link rotatably or pivotally coupled to the first and second handles. A first link pivot where the center link rotatably or pivotally couples to the second handle may be a first distance L1 away from a second jaw pivot where the second jaw rotatably or pivotally couples the second handle. A first jaw pivot where the second jaw rotatably or pivotally couples the first handle is a second distance L2 away from the second jaw pivot. In an embodiment, the first distance L1 is about 34% to about 70% of the second distance L2.

### TECHNICAL FIELD OF THE INVENTION

The present invention relates generally to locking-type pliers, and more particularly to locking-type pliers adapted to apply a clamping force to an object.

### BACKGROUND OF THE INVENTION

Locking pliers are an adjustable hand tool often used to grip a work piece, typically when other gripping methods have failed, such as on rounded fasteners, studs, or round shafts. The pliers generally include jaws that can be adjusted by a threaded screw mechanism to increase or decrease a gap between the jaws based on the size of the work piece or material being gripped by the locking pliers. For example, a locking-type pliers can include a screw mechanism on an upper handle of the pliers that, when rotated, pushes on a center link connected to one of the jaws to raise or lower the jaw, relative to the other jaw.

Locking pliers are also able to lock by moving the lower handle towards the upper handle until it “locks” due to, for example, an interaction between a release lever adjacent the lower handle and a center link connecting the upper handle to the lower handle. To release the locking feature, a release lever can then be lifted away from the lower handle to pry the lower handle away from the center link.

However, often it is difficult for a user to apply enough force to the handles of the pliers to lock the pliers and clamp the jaws of the pliers on the work piece. Further, in some cases, the user may not be able to apply enough force to the handles to create the desired jaw clamping force. An insufficient clamping force renders the gripping of the pliers on the work piece ineffective, and the jaws of the pliers can slip off of the work piece when the user attempts to manipulate the pliers.

### SUMMARY OF THE INVENTION

The present invention relates broadly to high leverage locking-type pliers. The pliers incorporate a four bar linkage system adapted to amplify force applied by a user to an object gripped between jaws of the pliers. The linkage system also includes an over-center lock adapted to keep or lock the jaws closed with no additional force from the user. For example, the pliers may include first and second handles, first and second jaws, and a center link rotatably or pivotally coupled to the first and second handles.

A first link pivot where a center link pivotally couples to the second handle may be a first distance L1 away from a second jaw pivot where the second jaw pivotally couples the second handle. Additionally, a first jaw pivot where the second jaw pivotally couples the first handle is disposed a second distance L2 away from the second jaw pivot. In this embodiment, the first distance L1 is about 34% to about 70% of the second distance L2, and preferably about 43.5% of the second distance L2. This results in an increased clamping force with all jaw types common on locking pliers, and a low user force required to lock the pliers (such as, a clamping force about 25 times greater than a user force).

In an embodiment, the present invention relates broadly to a tool having first and second handles and first and second jaws. The second jaw is coupled to the first handle at a first jaw pivot, and coupled to the second handle at a second jaw pivot. A center link is coupled to the first handle at a slideable pivot and coupled to the second handle at a link pivot. A first distance between the second jaw pivot and the link pivot is about 34% to about 70% of a second distance between the second jaw pivot and the first jaw pivot.

In another embodiment, the present invention relates broadly to a tool having first and second handles, and a jaw coupled to the first handle at a first jaw pivot, and coupled to the second handle at a second jaw pivot. A center link is coupled to the first handle at a slideable pivot and coupled to the second handle at a link pivot. A first distance between the second jaw pivot and the link pivot is about 34% to about 70% of a second distance between the second jaw pivot and the first jaw pivot.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is side view of exemplar pliers, according to an embodiment of the present invention.

FIG. 2 is side view of one handle and jaw of exemplar pliers, according to an embodiment of the present invention.

FIG. 3 is side view of one handle and jaw of exemplar pliers, according to an embodiment of the present invention.

### DETAILED DESCRIPTION

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to high leverage locking-type pliers. The pliers incorporate a four bar linkage system adapted to amplify force applied by a user to an object gripped between jaws of the pliers. The linkage system also includes an over-center lock adapted to keep or hold the jaws closed with no additional force from the user. For example, the pliers may include first and second handles, first and second jaws, and a center link pivotally coupled to the first and second handles. A first link pivot where the center link pivotally couples to the second handle may be a first distance L1 away from a second jaw pivot where the second jaw rotatably or pivotally couples the second handle. Additionally, a first jaw pivot where the second jaw pivotally couples the first handle is disposed a second distance L2 away from the second jaw pivot. In this embodiment, the first distance L1 is about 34% to about 70% of the second distance L2, and preferably about 43.5% of the second distance L2. This results in an increased clamping force with all jaw types common on locking-type pliers, and a low user force required to lock or clamp the pliers.

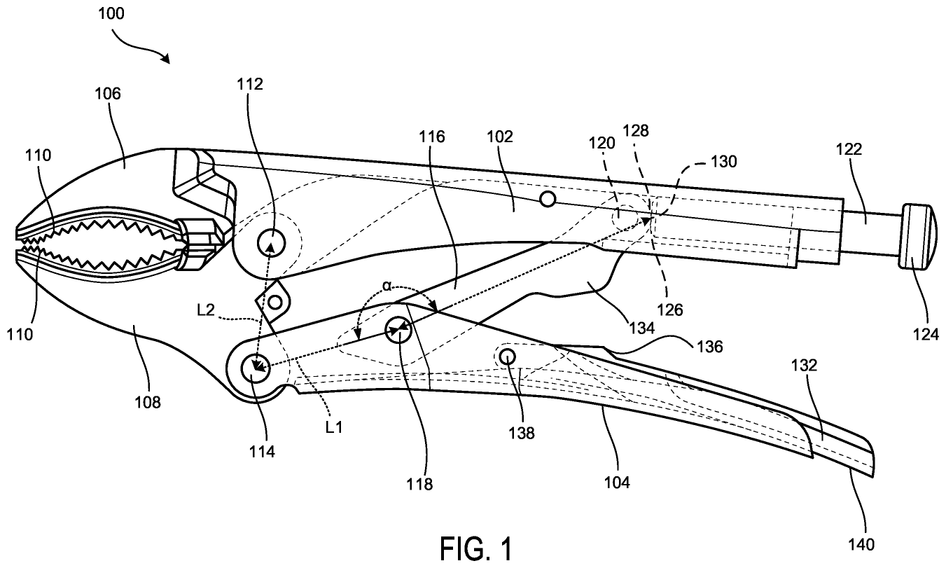

As shown in FIG. 1, a tool 100 such as locking-type pliers, includes a first handle 102 and a second handle 104 pivotally coupled to one another. First and second jaws 106, 108 are respectively coupled to the first and second handles 102, 104. As shown, each of the first and second jaws 106, 108 can include teeth 110 or knurling adapted to better grip or “bite” a work piece or other object disposed between the jaws. However, each of the first and second jaws 106, 108 can be other types of jaws and include other features. For example, and without limitation, the first and second jaws 106, 108 can be substantially flat clamping jaws, edged cutting jaws, needle-nose pliers type jaws, curved jaws, etc.

The first and second handles 102, 104 and the first and second jaws 106, 108 couple together at various pivot points to facilitate the operation of the tool 100. For example, the second jaw 108 can couple to the first handle 102 at a first jaw pivot 112 and can couple to the second handle 104 at a second jaw pivot 114. The second jaw 108 can also couple to the first handle 102 via an elastic member that pulls the first and second handles 102, 104 open or closed depending on the position of the first and second handles 102, 104. In an embodiment, the first handle 102 is fixedly coupled to the first jaw 106 and the second handle 104 is rotatably or pivotally coupled to the second jaw 108.

The tool 100 also includes a center link 116 pivotally coupled to the second handle 104 at a first link pivot 118, and pivotally and slidably coupled to the first handle 102 at a slideable pivot 120. The center link 116 interacts with an adjusting threaded screw mechanism 122 operably coupled to the first handle 102 that is adapted to adjust a jaw gap between the first and second jaws 106, 108. As shown, the adjusting screw 122 can include a head 124 on a first end and a contact surface 126 on a second end opposite the first end, with threads extending at least partially therebetween.

To adjust the jaw gap between the first and second jaws 106, 108, a user can rotate the head 124 of the adjusting screw mechanism 122 in a desired rotational direction and move the adjusting screw 122 axially inwardly or outwardly relative to a longitudinal axis of the first handle 102, based on the functionality of the threads. For example, for right handed threads, the user can rotate the head 124 of the adjusting screw mechanism 122 clockwise to thereby push the surface 126 of the adjusting screw mechanism 122 against a face 128 of the center link 116. In so doing, the center link 116 will push the second jaw 108 in a closing action towards the first jaw 106 at the second jaw pivot 114, and thereby decreasing the jaw gap between the first and second jaws 106, 108. Alternately, the user can rotate the head 124 of the adjusting screw mechanism 122 counterclockwise to increase the jaw gap between the first and second jaws 106, 108, by pulling at the second jaw pivot 114 in a manner opposite that described above.

In some embodiments, the tool 100 can lock or clamp in manner that fixes the jaw gap between the first and second jaws 106, 108, thereby clamping onto a work piece disposed between the first and second jaws 106, 108. To lock or clamp the tool 100, the second handle 104 is moved in a direction towards the first handle 102. A clamping force on the second jaw 108 is transmitted about pivot 112 and can be modeled as an imaginary line (referred to as the “power line”) from pivot 114 to a contact point 130 between the surface 126 and face 128. The tool 100 is locked or clamped when the second handle 104 is moved towards the first handle 102, but is prevented from moving further toward first handle 102 by interaction of protrusion 134 of the center link 116 and abutment 136 of release lever 132. As illustrated, the release lever 132 is coupled to the second handle 104 at release pivot 138.

To release the locking function, the tool 100 includes a reverse link 132 that can be moved away from the second handle 104 and thereby push against the center link 116. As shown, the center link 116 can include the protrusion 134 and the release lever 132 can include an abutment 136 that contact one another to prevent further closing of the first and second handles 102, 104 with respect to one another. The abutment 136 can further act as a first contact point during the releasing operation, when the user moves the release lever 132 at a tab 140 on the end of the release lever 132. Here, the abutment 136 can contact the protrusion 134 and pry the second handle 104 away from the center link 116 and/or first handle 102.

The tool 100 can also include an over-center locking feature, where the center link 116 can also include a protrusion that interacts with a release link. For example, such as the over-center locking feature described in U.S. Patent Application Publication No. 2020/0384613, titled Locking Pliers Release Mechanism, which is commonly owned with the present invention.

However, in prior designs, it can be difficult for a user to apply enough force to the handles of the pliers to lock the pliers and clamp the jaws of the pliers on a work piece. The present invention addresses this issue by disposing or placing the first link pivot 118 (where the center link 116 rotatably or pivotally couples to the second handle 104) a first distance L1 away from the second jaw pivot 114 (where the second jaw 108 rotatably or pivotally couples the second handle 104). Additionally, the first jaw pivot 112 (where the second jaw 108 rotatably or pivotally couples the first handle 102) is disposed or placed a second distance L2 away from the second jaw pivot 114.

In an embodiment, the first distance L1 is about 34% to about 70% of the second distance L2, and preferably about 43.5% of the second distance L2. Additionally, a first line extending through the second jaw pivot 114 and first link pivot 118, and a second line extending through the first link pivot 118 and contact point 130 are disposed apart by an angle α. In an example, the second distance L2 is about 1.465 inches, the first distance L1 is about 0.5 inches to about 1.0 inch, and preferably about 0.637 inches, and the angle α is about 171° to about 172°. This results in an increased clamping force with all jaw types common on locking-type pliers, and a lower user input force required to lock or clamp the pliers (clamp the first and second jaws), compared to prior designs. For example, in an embodiment, an input force of about 21.1 lbs. is required by a user to cause clamping or locking of the first and second jaws pliers, and the first and second jaws provide a clamping force of about 528.8 lbs. This results in a 25.1 mechanical advantage (i.e., the clamping force is about 25 times greater than the input force). The 25.1 mechanical advantage is greater than that provided by conventional designs.

For example, a first distance L1 that is about 107-108% of the second distance L2 requires an input force of about 60.1 lbs. by the user to cause clamping or locking of the first and second jaws pliers, and the first and second jaws provide a clamping force of about 460.7 lbs., resulting in a 7.7 mechanical advantage. In another example, a first distance L1 that is about 83% of the second distance L2 requires an input force of about 39.3 lbs. by the user to cause clamping or locking of the first and second jaws pliers, and the first and second jaws provide a clamping force of about 488.5 lbs., resulting in a 12.4 mechanical advantage.

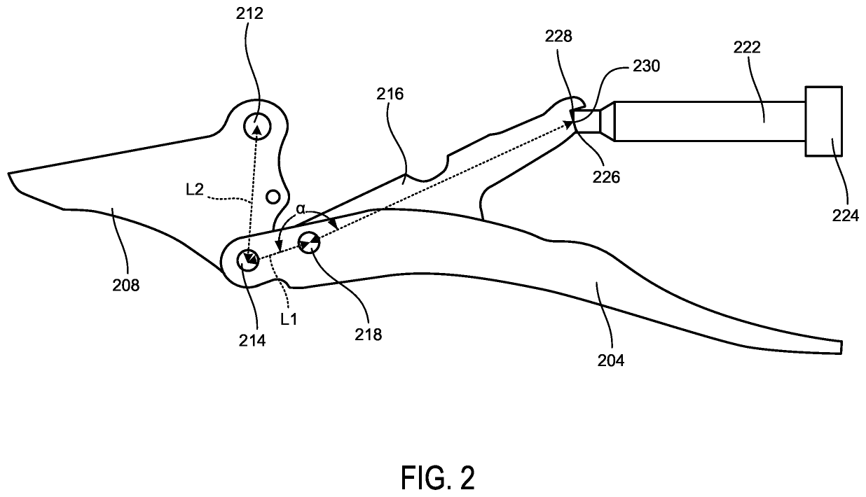

As mentioned above, the first and second jaws 106, 108 can be other types of jaws and include other features. Referring to FIG. 2, a second half of another embodiment of exemplar pliers is shown, and may include a second jaw 208 that includes a cutting surface. Similar to the exemplar pliers 100 described above, the second half of the pliers includes a second handle 204 and second jaw 208. The second jaw 208 can couple to a first handle at a first jaw pivot 212 and can couple to the second handle 204 at a second jaw pivot 214. In an embodiment, the second handle 204 is pivotally coupled to the second jaw 208. A center link 216 is also pivotally coupled to the second handle 204 at a first link pivot 218, and pivotally and slidably coupled to the first handle at a slideable pivot. The center link 216 interacts with an adjusting screw mechanism 222 operably coupled to the first handle to adjust a jaw gap. As shown, the adjusting screw mechanism 222 can include a head 224 on a first end and a contact surface 226 on a second end opposite the first end, with threads extending at least partially therebetween. The surface 226 of the adjusting screw mechanism 222 abuts a face 228 of the center link 216 at a contact point 230.

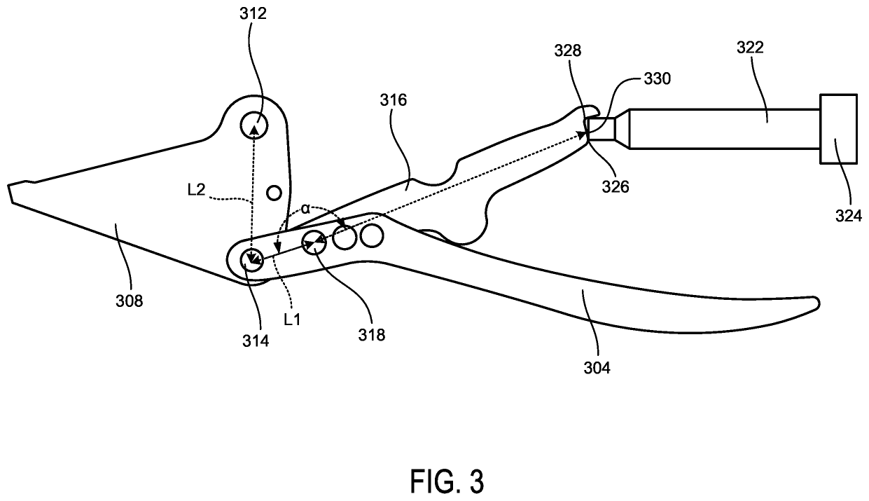

Referring to FIG. 3, a second half of another embodiment of exemplar pliers is shown, and may include a second jaw 308 that includes a substantially flat surface. Similar to the exemplar pliers 100 described above, the second half of the pliers includes a second handle 304 and second jaw 308. The second jaw 308 can couple to a first handle at a first jaw pivot 312 and can couple to the second handle 304 at a second jaw pivot 314. In an embodiment, the second handle 304 is pivotally coupled to the second jaw 308. A center link 316 is also pivotally coupled to the second handle 304 at a first link pivot 318, and pivotally and slidably coupled to the first handle at a slideable pivot. The center link 316 interacts with an adjusting screw mechanism 322 operably coupled to the first handle to adjust a jaw gap. As shown, the adjusting screw mechanism 322 can include a head 324 on a first end and a contact surface 326 on a second end opposite the first end, with threads extending at least partially therebetween. The surface 326 of the adjusting screw mechanism 322 abuts a face 328 of the center link 316 at a contact point 330.

Similar to the exemplar pliers 100, the first link pivot 218/318 (where the center link 216/316 rotatably or pivotally couples to the second handle 204/304) is a first distance L1 away from the second jaw pivot 214/314 (where the second jaw 208/308 rotatably or pivotally couples the second handle 204/304). Additionally, the first jaw pivot 212/312 (where the second jaw 208/308 rotatably or pivotally couples the first handle) is disposed a second distance L2 away from the second jaw pivot 214/314.

In an embodiment, the first distance L1 is about 34% to about 70% of the second distance L2, and preferably about 43.5% of the second distance L2. Additionally, a first line extending through the second jaw pivot 214/314 and first link pivot 218/318, and a second line extending through the first link pivot 218/318 and contact point 230/330 are disposed apart by an angle α. In an example, the second distance L2 is about 1.465 inches, the first distance L1 is about 0.5 inches to about 1.0 inch, and more particularly about 0.637 inches, and the angle α is about 171° to about 172°. This results in an increased clamping force with all jaw types common on locking-type pliers, and a low user force required to lock the pliers compared to prior designs.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool having first and second handles and first and second jaws, the tool comprising:
a first jaw pivot coupling the second jaw to the first handle;
a second jaw pivot coupling the second jaw to the second handle; and
a center link coupled to the first handle at a slideable pivot and coupled to the second handle at a link pivot, wherein a first distance between the second jaw pivot and the link pivot is about 34% to about 70% of a second distance between the second jaw pivot and the first jaw pivot.

2. The tool of claim 1, wherein the first distance is about 43.5% of the second distance.

3. The tool of claim 1, wherein the first distance is about 0.5 inches to about 1.0 inch.

4. The tool of claim 1, wherein the first distance is about 0.637 inches.

5. The tool of claim 1, wherein the first and second distances provide a clamping force between the first and second jaws that is about 25 times greater than an input force to push the first and second handles together to clamp the first and second jaws.

6. The tool of claim 1, further comprising an adjustment screw mechanism having a head on a first end and a point on a second end and threads extending at least partially therebetween, the adjustment screw mechanism being threadably inserted into the first handle for adjusting a gap between the first and second jaws.

7. The tool of claim 6, wherein the adjustment screw mechanism is adapted to be rotated clockwise to reduce the gap, and is adapted to be rotated counterclockwise to increase the gap.

8. The tool of claim 7, wherein the center link includes a face and wherein a point of contact of the adjustment screw mechanism abuts the face during an adjustment operation in which the gap is adjusted.

9. The tool of claim 1, further comprising a release lever rotatably coupled to the second handle and having an abutment protruding from the release lever and an extension extending from an end of the release lever, and wherein the center link includes a protrusion protruding from the center link towards the second handle, wherein the abutment abuts the protrusion when the first and second jaws are in a closed state and is spaced from the protrusion then the first and second jaws are in an open state.

10. A tool comprising:
first and second handles;
a jaw coupled to the first handle at a first jaw pivot, and coupled to the second handle at a second jaw pivot; and
a center link coupled to the first handle at a slideable pivot and coupled to the second handle at a link pivot, wherein a first distance between the second jaw pivot and the link pivot is about 34% to about 70% of a second distance between the second jaw pivot and the first jaw pivot.

11. The tool of claim 10, wherein the first distance is about 43.5% of the second distance.

12. The tool of claim 10, wherein the first distance is about 0.5 inches to about 1.0 inch.

13. The tool of claim 10, wherein the first distance is about 0.637 inches.
